(19) United States
(12) Patent Application Publication
(10) Pub. No.: US 2012/0106016 A1
(43) Pub. Date: May 3, 2012

(54) Fuse Link System For A Hyperthermia Apparatus

(75) Inventors: J. Michael Fausset, Lafayette, IN (US); Michael Sturdevant, Concord Twp., OH (US); Robert Schindler, Euclid, OH (US); Michael Terry, Akron, OH (US)

(73) Assignee: THERMALTHERAPEUTIC SYSTEMS, INC., Pittsburgh, PA (US)

(21) Appl. No.: 12/913,275

(22) Filed: Oct. 27, 2010

(51) Int. Cl. H02H 5/04

(52) U.S. Cl. 361/104

(57) ABSTRACT

A fuse system for a hyperthermia apparatus may include a disposable reservoir cartridge configured to be used with a hyperthermia apparatus. The disposable reservoir cartridge may include at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium may include one or more programming instructions for deactivating the first fuse link at a first time, and deactivating the second fuse link at a second time.

### CROSS REFERENCE TO RELATED APPLICATIONS

This application is related to U.S. patent application Ser. No. 12/054,013, filed Mar. 24, 2008, and U.S. patent application Ser. No. 12/913,167, filed Oct. 27, 2010, the entireties of which are hereby incorporated by reference.

### BACKGROUND

The use of a thermal therapy device to deliver intraperitoneal hyperthermia in conjunction with surgery and/or chemotherapy has resulted in positive survival and quality of life outcomes for patients who may have otherwise had only weeks or months to live. The dramatic response is due in part to direct contact of heat or medication and heat with diseased areas. Intraperitoneal hyperthermia has proven a successful treatment for numerous ailments, including, but not limited to, cancer. Exposing affected cells to heat, therapeutic agents and/or medication has a more aggressive and profound effect on patient outcomes.

Conventional hyperthermia apparatuses that utilize disposable components typically include single-use connectors and/or fuses to ensure that the disposable components are used only once. However, certain actions other than device use, such as unexpected power outages and user adjustments of the disposable component, can trigger the fuse. As such, the disposable set is rendered unusable, and a new disposable set must be installed. This is neither cost-efficient nor time-efficient for a user.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

In an embodiment, a fuse system for a hyperthermia apparatus may include a disposable reservoir cartridge configured to be used with a hyperthermia apparatus. The disposable reservoir cartridge may include at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium may include one or more programming instructions for deactivating the first fuse link at a first time, and deactivating the second fuse link at a second time.

In an embodiment, a fuse system for a hyperthermia apparatus may include a disposable reservoir cartridge configured to be used with a hyperthermia apparatus. The disposable reservoir cartridge may include at least a first lockout circuit and a second lockout circuit. The first lockout circuit may include a first fuse link, and the second lockout circuit may include a second fuse link. The fuse system may include a computing device in communication with the first lockout circuit and the second lockout circuit, and a computer-readable storage medium in communication with the computing device. The computer-readable storage medium includes one or more programming instructions for deactivating the first fuse link at a start of a procedure, and deactivating the second fuse at a time after the first fuse link is deactivated.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

Aspects, features, benefits and advantages of the present invention will be apparent with regard to the following description and accompanying drawings, of which:

FIG. 1 depicts exemplary elements of a hyperthermia apparatus according to an embodiment.

FIG. 2 depicts exemplary elements of a hyperthermia apparatus operating in prime mode according to an embodiment.

FIG. 3 depicts exemplary elements of a hyperthermia apparatus contained in a housing according to an embodiment.

FIG. 4 depicts an exemplary reservoir cartridge and screen according to an embodiment.

FIG. 5 depicts an exemplary pressure isolator according to an embodiment.

FIG. 6 illustrates an exemplary lockout circuit according to an embodiment.

FIG. 7 illustrates an exemplary method of deactivating fuse links according to an embodiment.

### DETAILED DESCRIPTION

It must be noted that as used herein and in the appended claims, the singular forms “a,” “an,” and “the” include plural reference unless the context clearly dictates otherwise. Thus, for example, reference to a “pump” is a reference to one or more pumps and equivalents thereof known to those skilled in the art, and so forth. Unless defined otherwise, all technical and scientific terms used herein have the same meanings as commonly understood by one of ordinary skill in the art.

As used herein, the term “comprising” means “including, but not limited to.” As used herein, the term “about” means plus or minus 10% of the numerical value of the number with which it is being used. For example about 50% means in the range of 45%-55%.

As used herein, the term “therapeutic agent” means an agent utilized to treat, combat, ameliorate or prevent an unwanted condition or disease of a patient. In an embodiment, a therapeutic agent may include a chemotherapeutic agent.

“Administering” when used in conjunction with a therapeutic agent means to administer a therapeutic agent into or onto a target tissue or to administer a therapeutic agent to a patient whereby the therapeutic agent positively impacts the tissue to which it is targeted. “Administering” a composition may be accomplished by oral administration, injection, infusion or absorption or in conjunction with intraperitoneal hyperthermia or by a combination of such techniques. Such techniques may further include heating, radiation and ultrasound.

The term “target”, as used herein, refers to the material for which either deactivation, rupture, disruption or destruction or preservation, maintenance, restoration or improvement of function or state is desired. For example, diseased cells, pathogens, or infectious material may be considered undesirable material in a diseased subject and may be a target for therapy.

The term “treating” may be taken to mean prophylaxis of a specific disorder, disease or condition, alleviation of the symptoms associated with a specific disorder, disease or condition and/or prevention of the symptoms associated with a specific disorder, disease or condition.

The term “patient” generally refers to any living organism to which to compounds described herein are administered and may include, but is not limited to, any non-human mammal, primate or human. Such “patients” may or my not be exhibiting the signs, symptoms or pathology of the particular diseased state.

The terms “effective” or “therapeutically effective” as used herein may refer to eliciting a biological or medicinal response in a tissue, organ, system, animal, individual or human that is being sought by a researcher, veterinarian, medical doctor or other clinician. A biological or medicinal response may include, for example, one or more of the following: (1) inhibiting a disease, condition or disorder in an individual that is experiencing or displaying the pathology or symptoms of the disease, condition or disorder or arresting further development of the pathology and/or symptoms of the disease, condition or disorder, and (2) ameliorating a disease, condition or disorder in an individual that is experiencing or exhibiting the pathology or symptoms of the disease, condition or disorder or reversing the pathology and/or symptoms experienced or exhibited by the individual.

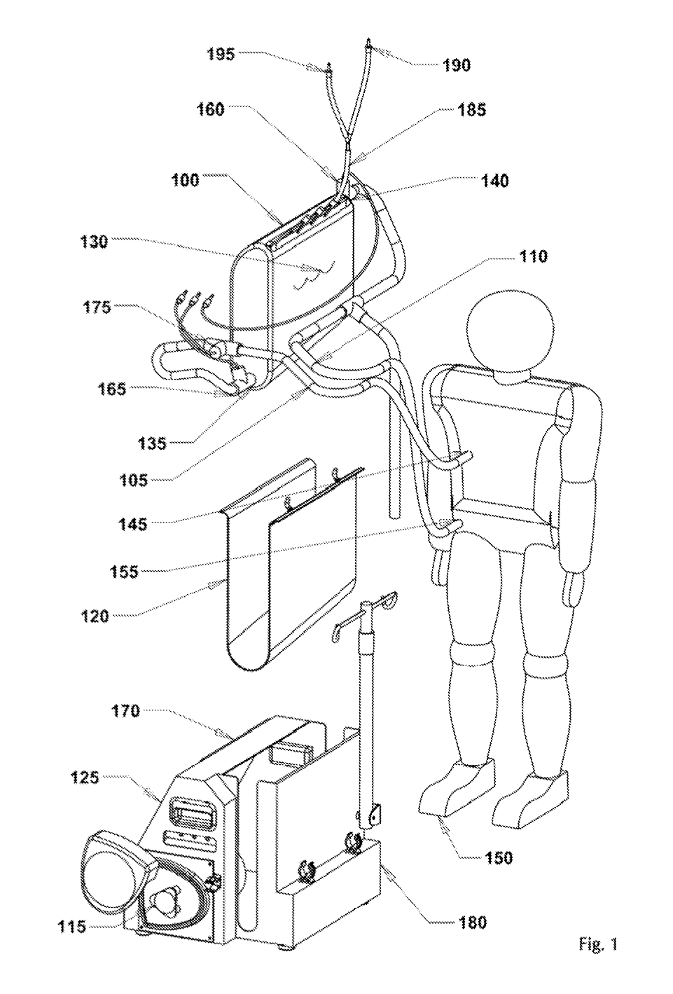

In an embodiment, a hyperthermia apparatus of the invention, as illustrated in FIG. 1, includes reservoir cartridge 100, outflow tube 105, inflow tube 110, pump 115, heater 120, computer 125 and housing 180.

In an embodiment, heater 120 may be in close proximity to reservoir cartridge 100 to maximize heat transfer. Heater 120 may be, for example, a thermoelectric heater for providing electric heat to fluid 130. A thermoelectric heater may facilitate direct heat transfer to fluid 130. In alternative embodiments, heater 120 is any type of heater known in the art, such as a water bath, immersion heater or the like.

In an embodiment, computer 125 may be an integrated computer, meaning that the computer and visual display are in the same unit. In an embodiment, computer 125 may be in communication with a computer-readable storage medium, which may include one or more programming instructions. In one embodiment, the visual display may be a touch-screen. In another embodiment, computer 125 may be removable from housing 180. For example, computer 125 may be removed from housing 180 prior to transport of the apparatus, and connected to the apparatus prior to treatment of a patient.

In an embodiment, reservoir cartridge 100 stores or receives fluid 130 to be administered to a patient. Reservoir cartridge 100 may be disposable, and may have an inlet 140 and an outlet 135. In an embodiment, reservoir cartridge 100 may include two or more lockout circuits, resistor circuits and/or the like. In an embodiment, a lockout circuit may be located in the reservoir cartridge 100 near the inlet 140, the outlet 135 or other connector of the reservoir cartridge. In an embodiment, a lockout circuit may be located in the inlet 140 and/or the outlet 135. In an embodiment, a lockout circuit may be located in additional and/or alternate locations on the reservoir cartridge 100.

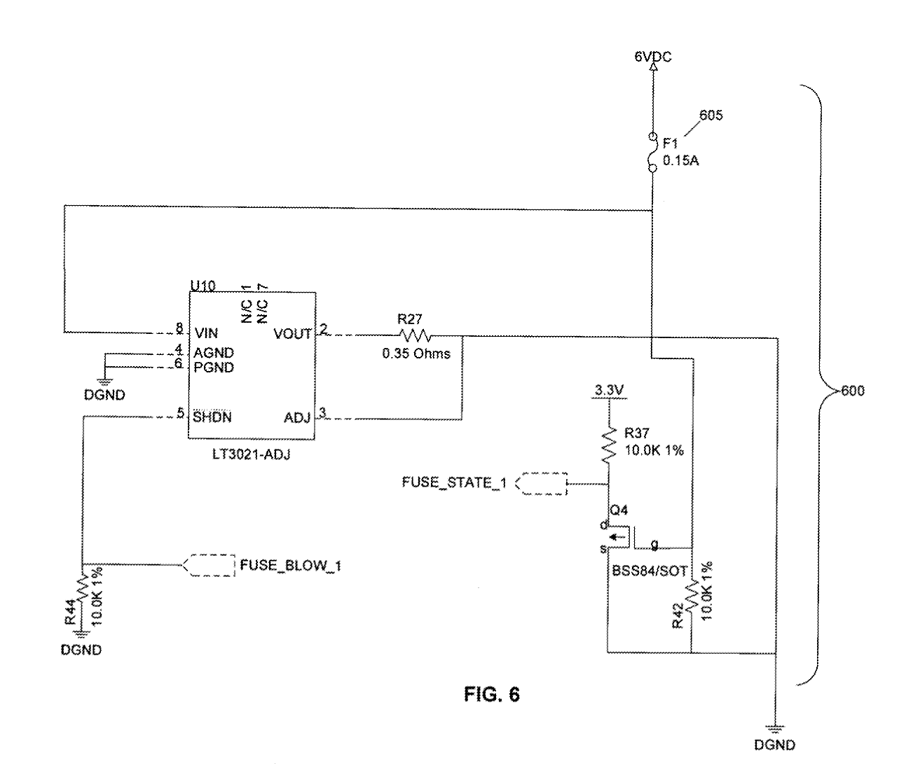

FIG. 6 illustrates an exemplary lockout circuit 600 that may be used according to an embodiment. As illustrated by FIG. 6, a lockout circuit 600 may include one or more fuse links 605. In an embodiment, the fuse links 605 may be mechanical, electrical and/or the like. In an embodiment, a first mechanical fuse link of a reservoir cartridge 100 may be broken during installation of the reservoir cartridge 100. A second mechanical fuse link of the reservoir cartridge 100 may be broken when the reservoir cartridge 100 is disconnected from the hyperthermia apparatus. The reservoir cartridge 100 may be operable so long as at least one of the fuses are intact. If both fuses are broken, the reservoir cartridge 100 may not function or operate.

In an embodiment, the computer 125 may open or otherwise deactivate electrical fuse links 605 at certain times to prevent unauthorized use of and/or re-use of disposable components, such as the reservoir cartridge 100.

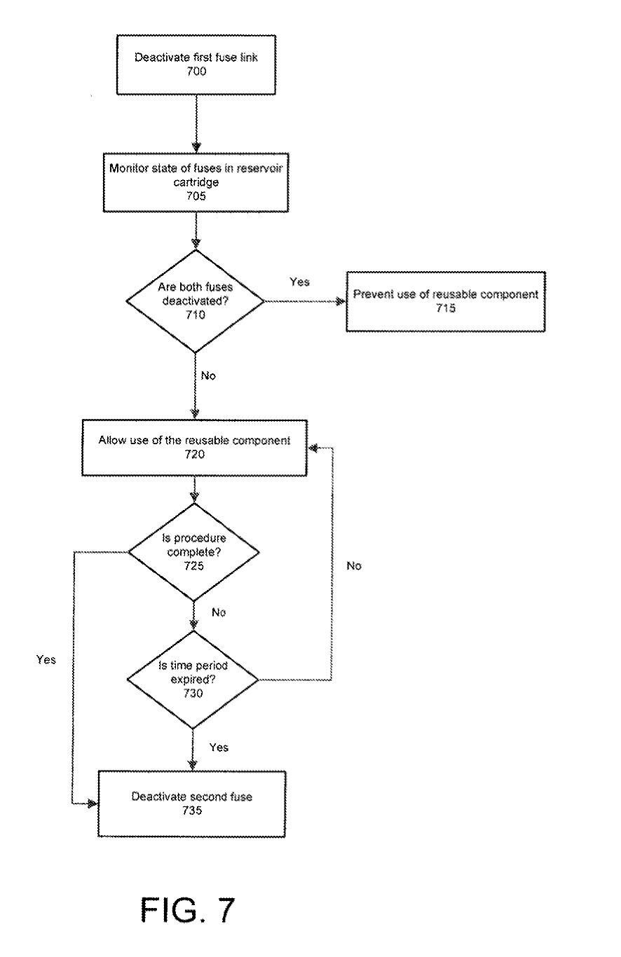

FIG. 7 illustrates an exemplary method of deactivating electrical fuse links according to an embodiment. As illustrated by FIG. 7, a first fuse link may be deactivated 700 by the computer 125 when a hyperthermia apparatus is powered on. Alternatively, a first fuse link may be deactivated at a certain time after a hyperthermia apparatus is powered on. For example, a first fuse link may be deactivated one minute after a hyperthermia apparatus is powered on. Additional and/or alternate time periods may be used within the scope of this disclosure.

In an embodiment, the computer 125 may monitor 705 the state of the fuses during and/or after power up of the hyperthermia apparatus. If both fuse links are deactivated 710, the computer may prevent 715 use of the reservoir cartridge 100. In an embodiment, the computer 125 may prevent use of the reservoir cartridge 100 by powering off the hyperthermia apparatus. In an embodiment, the computer 125 may display a notification to a user that the reservoir cartridge 100 is no longer operable.

In an embodiment, the computer 125 may allow 720 use of the reservoir cartridge 100 if both fuse links are intact or if one of the fuse links is intact. For example, the computer 125 may allow 720 use of the reservoir cartridge 100 if the first and second fuse links are intact or if the second fuse link is intact. As such, a user may connect and reconnect the reservoir cartridge 100 as many times as necessary during installation without risk of disabling the reservoir cartridge. In addition, a new reservoir cartridge may not need to be installed if the hyperthermia apparatus experiences a power outage or if power is otherwise interrupted.

In an embodiment, the second fuse link may be deactivated 735 by the computer 125 at the end of a procedure 725. For example, the computer 125 may deactivate 735 a second fuse link when the hyperthermia apparatus is powered off. In an alternate embodiment, the computer 125 may receive notification of the completion of a procedure from a user. For example, a user may push a button, select an icon or otherwise inform the computer 125 that the procedure has been completed. At this time, the computer 125 may deactivate 735 the second fuse link. It is understood that the fuse links may be deactivated 735 at alternate times within the scope of this disclosure.

In an embodiment, the computer 125 may deactivate 735 the second fuse link after a certain time period has expired 730. For example, the computer 125 may deactivate 735 the second fuse link after a certain time period 730 from when hyperthermia apparatus was powered on. For instance, the computer 125 may deactivate the second fuse link eight hours after the apparatus has been powered on. Alternatively, the computer 125 may deactivate 735 the second fuse link a certain time period after the first fuse link was deactivated.

In an embodiment, the computer may deactivate 735 the second fuse link if the computer 125 does not receive confirmation of completion of a procedure within a certain time period. For instance, a procedure may be scheduled for five hours. If the computer 125 does not receive confirmation of completion of the procedure within one hour of the scheduled time of completion, the computer may deactivate 735 the second fuse link.

In an embodiment, reservoir cartridge 100 may comprise one or more inlets and/or outlets. The inlets and/or outlets may be sealed to prevent the escape of fluid 130, and may facilitate the maintenance of a sterile environment when reservoir cartridge 100 is not connected to the hyperthermia apparatus.

In an embodiment, fluid 130 may be contained in reservoir cartridge 100. Fluid 130 may be introduced into reservoir cartridge 100 via fluid introduction tube 185. Fluid introduction tube 185 may include one or more valves, clamps, or inlets to allow one to introduce a physiologically compatible solution such as a drug into fluid 130 at a controlled rate. Such devices are known in the art and include, for example, IV spikes 190, 195.

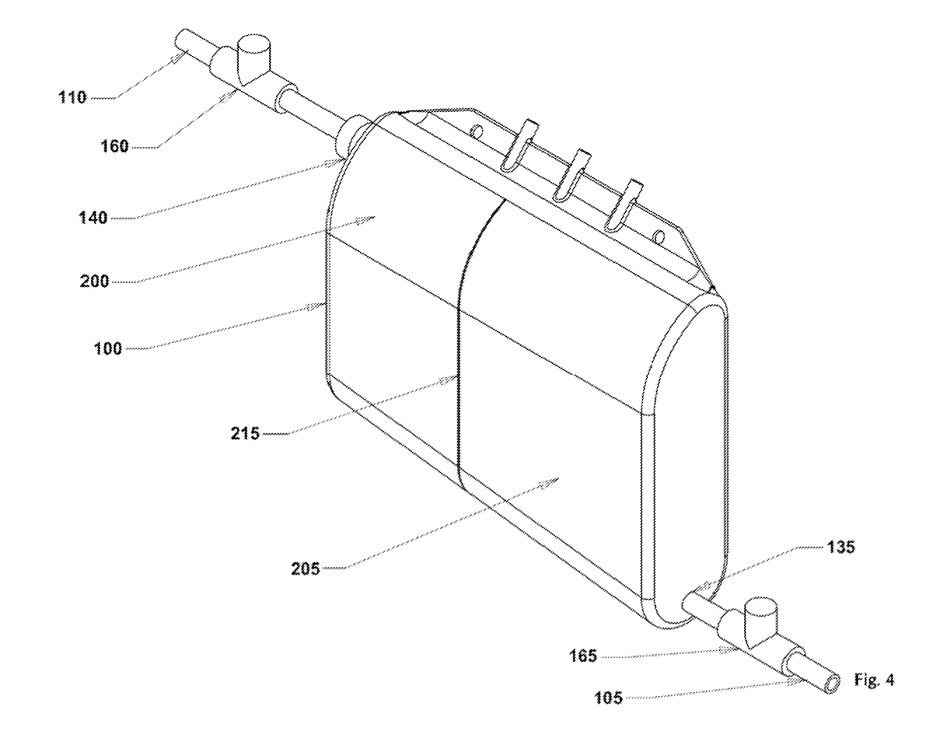

In an embodiment, reservoir cartridge 100 may be fabricated from PVC plastic film and/or other plastic materials. Reservoir cartridge 100 may be RF welded and/or RF heat sealed. In an embodiment, reservoir cartridge 100 may comprise a screen 215. FIG. 4 illustrates an exemplary reservoir cartridge 100 and screen 215. Screen 215 may be located in the proximity of inlet 140. In an embodiment, screen 215 may divide reservoir cartridge 100 into an inflow chamber 200 and an outflow chamber 205. Inflow chamber 200 may receive fluid 130 from inflow tube 110. Fluid 130 may pass through screen 215 into second chamber 205. Screen 215 may filter macroscopic residue, such as fatty tissue, from fluid 130 returning to reservoir cartridge 100 via inflow tube 110. Screen 215 may be fabricated from plastic and/or the like and may be disposable. Screen 215 may be able to filter particles having a size of about 100-140 microns or larger.

In an embodiment, fluid 130 comprises a sterile fluid. In another embodiment, fluid 130 comprises drugs, medication or the like. In an embodiment, hyperthermia assists to render a chemotherapeutic agent more effective against a target disease than the agent would be without the use of hyperthermia. In an embodiment, fluid 130 may comprise one or more chemotherapeutic agents such as cyclophosphamide, doxorubicin, melphalan, mitomycin C, cisplatin, gemcitabine, mitoxantrone, oxaliplatin, etoposide, irinotecan, paclitaxel, docetaxel, 5-Fluorouracil, floxuridine, carboplatin, or other chemotherapeutic agents as would be well-known by one of skill in the art.

In an embodiment, reservoir cartridge 100 and fluid 130 are heated by heater 120. Because heater 120 may be utilized to maximize heat transfer, the apparatus' power consumption may be up to about 15 amps. Alternatively, other power consumption values may be up to about 30 amps.

In an embodiment, once fluid 130 reaches a desired temperature, it may be pumped through outflow tube 105 to patient 150 via pump 115. In an embodiment, outflow tube 105 is disposable, with a proximal end and a distal end. Outflow tube 105 is connected at its proximal end (reservoir cartridge end) to reservoir cartridge 100 at outlet 135, while the distal end (outflow catheter end) of outflow tube 105 is connected to outflow catheter 145. Outflow catheter 145 may be inserted into a patient 150.

In an embodiment, pump 115 may be a paddle wheel, a roller pump, a pulsatile pump, centrifugal pump and/or the like. In an embodiment, pump 115 is in contact with outflow tube 105, and pumps fluid 130 at a rate of up to about 4,000 ml per minute. The high flow rate as compared to prior devices may be critical in providing beneficial treatment by maximizing contact of fluid with a patient. In addition, a high flow rate maintains the temperature of the fluid, which is an important feature of effective hyperthermia. The flow rate in combination with heat provided by a fluid may thereby increase the efficacy of a hyperthermia treatment.

In an embodiment, fluid 130 is administered to a patient 150, and is then re-circulated to reservoir cartridge 100 through inflow tube 110. Re-circulation of the heated fluid may be used to elevate a patient's core temperature and/or to maintain an elevated temperature for a period of time.

In an embodiment, inflow tube 110 is disposable, with proximal and distal ends. Inflow tube 110 may be connected at its distal end (inflow catheter end) to a patient 150 via inflow catheter 155, and may be connected at its proximal end (reservoir cartridge end) to reservoir cartridge 100 at inlet 140. Fluid 130 coming from patient 150 may be re-heated in reservoir cartridge 100, and once again pumped to a patient 150. This process may continue for a specified period of time with multiple cycles of re-circulation, as may be desired for a given therapeutic effect.

In an embodiment, one or more of inflow tube 110 and outflow tube 105 may comprise a flange or other similar portion. Inflow tube 110 may have a flange at its distal end (inflow catheter end) and outflow tube 105 may have a flange at its distal end (outflow catheter end). The flange may be fabricated from plastic and/or any other suitable material. In an embodiment, the flange may assist a physician or other healthcare professional to more quickly and efficiently suture the inflow tube 110 and/or the outflow tube 105 to the patient 150. Moreover, the flange may serve as a seal for the distal end (inflow catheter end) of the inflow tube 110 and/or the distal end (outflow catheter end) of the outflow tube 105.

According to an embodiment, the hyperthermia apparatus of the invention includes sensors for monitoring the temperature and pressure of the fluid. In an embodiment, a temperature sensor may be a standard thermistor, an infrared thermistor or the like. As illustrated in FIG. 1, temperature sensors 160, 165 may be located in reservoir cartridge 100 at the proximal ends of inflow tube 110 and outflow tube 105. Temperature sensors 160, 165 may allow monitoring of a fluid's 130 temperature as it both enters and leaves reservoir cartridge 100. In an embodiment, temperature sensors 160, 165 are disposable. In an embodiment, temperature sensors 160, 165 are in communication with a computer 125.

In an embodiment, a system for implementing hyperthermia may include one or more auxiliary temperature sensors and a hyperthermia apparatus such as that described in this disclosure. The auxiliary temperature sensors may be placed on and/or in the patient at various locations. One or more auxiliary temperature sensors may be plug-in thermistors that may be connected to the hyperthermia apparatus via a standard connection or the like. In another embodiment, one or more auxiliary temperature sensors may communicate with the hyperthermia apparatus wirelessly. In an embodiment, a healthcare professional may select one of the auxiliary temperature sensors to use as a reference. The healthcare professional may be able to monitor the temperature at the location of the auxiliary temperature sensors, and the hyperthermia apparatus may control the temperature of the fluid based on the selected auxiliary temperature sensor rather than the temperature sensors 160, 165 located in the hyperthermia apparatus.

As illustrated in FIG. 1, pressure sensor 175 is located, according to an embodiment, in outflow tube 105 near reservoir cartridge 100. Preferably, pressure sensor 175 is located within outflow tube 105 downstream from pump 115. In an embodiment, pressure sensor 175 is located within outflow tube 105 immediately downstream from pump 115. Pressure sensor 175 may allow monitoring of fluid's 130 pressure as fluid 130 leaves reservoir cartridge 100. In an embodiment, pressure sensor 175 is in communication with computer 125. In an embodiment, pressure sensor 175 is disposable.

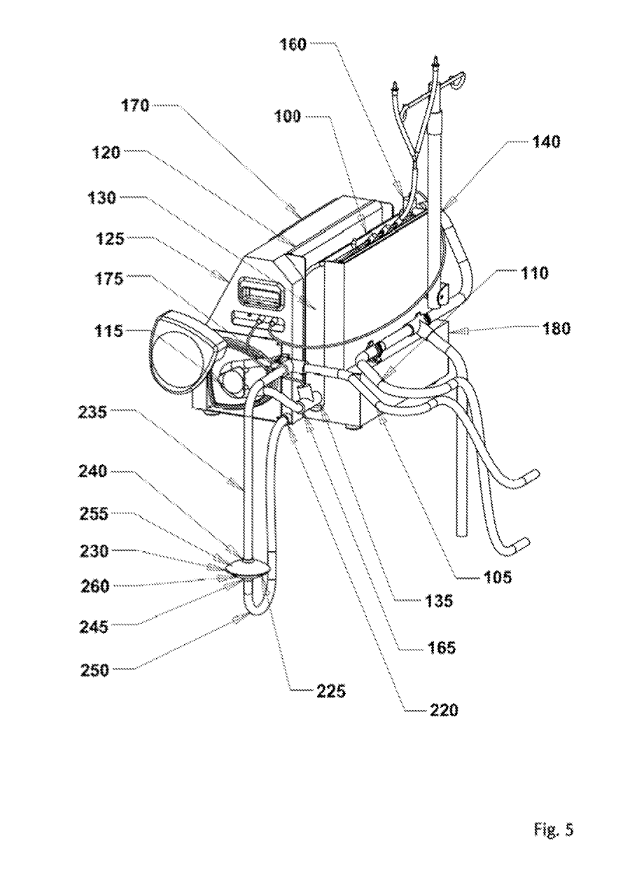

In another embodiment, housing may contain a pressure sensor 220. Pressure sensor 220 may be durable. Pressure sensor 220 may measure pressure of fluid 130 via a pressure isolator 225. As illustrated by FIG. 5, pressure isolator 225 may comprise a first chamber 255, a second chamber 260, an inlet 240, an outlet 245 and/or a membrane 230. A first connector tube 235 may connect outflow tube 105 to inlet 240. A second connector tube 250 may connect outlet 245 to pressure sensor 220. Membrane 230 may separate first chamber 255 from second chamber 255. Membrane 230 may be fluid impermeable and may prevent fluid 130 from coming into contact with pressure sensor 220. In an embodiment, pressure sensor 220 may measure the pressure of fluid 130 based on a pressure differential between first chamber 255 and second chamber 260.

Although the figures illustrates specific placements of temperature sensors 160, 165 and pressure sensors 175, 220 it is understood that sensors 160, 165, 175, 220 may be placed in different locations on the apparatus. In addition, one or more of temperature sensors 160, 165 and pressure sensors 175, 220 may wirelessly communicate with computer 125. Moreover, additional temperature and/or pressure sensors may be implemented by the device of the invention.

The apparatus of the invention may be used to monitor a fluid's 130 temperature while the fluid is in reservoir cartridge 100, which may allow for accurate temperature control to within about plus or minus one-half of one degree Centigrade (0.5° C.). In other words, the temperature variation of a fluid from when it leaves reservoir cartridge 100 to when it enters a patient 150 may be, for example, about 0.5° C. or less. In a preferred embodiment, the temperature of fluid 130 in reservoir cartridge 100 does not exceed about 43° C. As such, the temperature of fluid 130 when administered to a patient 150 preferably does not exceed about 42.5° C. The temperature of a fluid 130 in reservoir cartridge 100 may be maintained at a temperature other than 43° C., for example, any temperature desired by an operator to achieve the desired therapeutic effect, or for operation of the device in prime mode, as described below.

Computer 125 and touch screen 170 are, in one embodiment, configured to provide audible and visible alarms if certain conditions occur. For example, if the temperature of a fluid 130 in reservoir cartridge 100 exceeds a specified temperature, a visible and/or audible alarm may be triggered. Likewise, if the pressure or temperature of fluid 130 exceeds a preset threshold, a visible and/or audible alarm may be triggered.

As a safety precaution, heater 120, according to one embodiment, stops providing heat if a fluid's 130 temperature exceeds a specified temperature. In an embodiment, heater 120 stops providing heat if fluid's 130 pressure exceeds a specified level.

Similarly, pump 115, in an embodiment, stops pumping fluid 130 if the fluid's 130 pressure exceeds a specified level. In an embodiment, pump 115 stops pumping fluid 130 if fluid's 130 temperature exceeds a specified level.

Computer 125 may include a processor and a processor-readable storage medium. Computer 125 is programmable and capable of receiving input from a user. For example, a user may specify temperature levels, pressure levels or the like via the touch screen 170 or other input interfaces. A user may also input other information, such as the duration of the treatment, the amount of time the apparatus is to operate in prime mode or the like. In an embodiment, computer 125 may record data such as measurements associated with treatment and the like. For example, during the treatment of a patient, computer 125 may record one or more temperatures at one or more temperature sensors 160, 165, auxiliary temperature sensors and/or the like. Computer 125 may also record flow rates, pressure values, treatment time and/or the like.

Computer 125 is in communication with pump 115, heater 120, temperature sensors 160, 165, and pressure sensor 175, 220. Computer 125 controls the operation of pump 115 and monitors temperature sensors 160, 165 and pressure sensors 175, 220. In an embodiment, if the temperature or pressure of fluid 130 exceeds a specified level, computer 125 provides audible and visual alarm signals. In another embodiment, computer 125 shuts off heater 120 if fluid's 130 temperature exceeds a specified temperature or if fluid's 130 temperature is outside a specified range of temperatures. Likewise, in an embodiment, computer 125 shuts off pump 115 if fluid's 130 pressure exceeds a specified pressure level or if fluid's 130 pressure is outside a specified range of pressure levels. Computer 125 may shut off pump 115 if fluid's 130 temperature exceeds a specified temperature or if fluid's 130 temperature is outside a specified range of temperatures. Similarly, computer 125 may shut off heater 120 if fluid's 130 pressure level exceeds a specified pressure level or if fluid's 130 pressure level is outside a specified range of pressure levels.

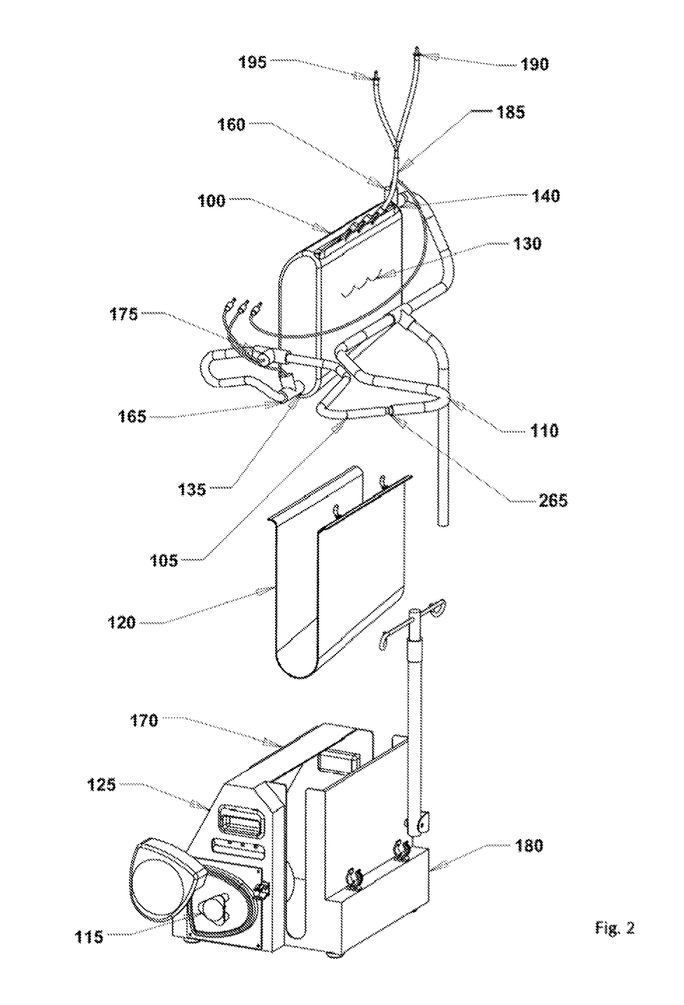

In an alternate embodiment, the apparatus of the invention operates without being connected to a patient. This is referred to as “prime mode” and is illustrated in FIG. 2. In prime mode, the apparatus prepares fluid 130 to be administered to a patient by heating and re-circulating fluid 130. In prime mode, outflow tube 105 may be connected to the inflow tube 110 via connector 265. A variety of tubing connectors suitable for use in the invention are known in the art and may include, for example, a barbed tubing connector or the like, or other connector as may be suitable to achieve the desired connector function. As such, the fluid 130 may be pumped from reservoir cartridge 100 through outflow tube 105 through connector 265 and back to reservoir cartridge 100 through inflow tube 110. Fluid 130 may be pumped for a specified period of time before fluid 130 is administered to a patient. When operating in prime mode, the temperature of fluid 130 in the reservoir may be maintained at a temperature up to, for example, 53° C. The device of the invention may be run in prime mode to ensure that the temperature of fluid 130 does not drop below an acceptable level before the apparatus is connected to a patient. An operator may set a time period for the apparatus to operate in prime mode.

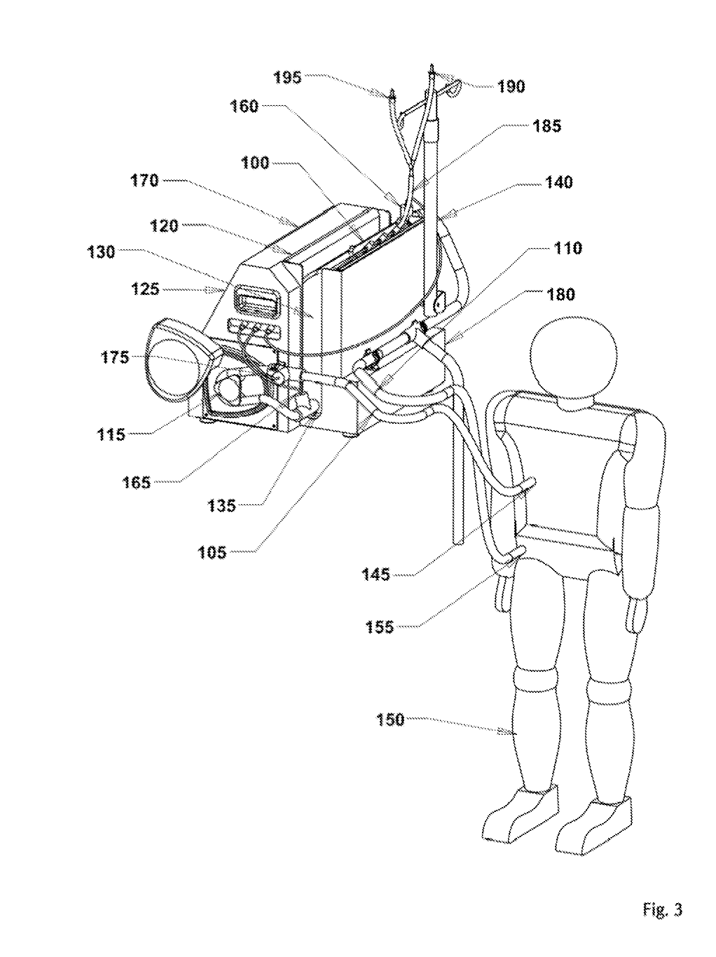

In an embodiment, reservoir cartridge 100, heater 120 and computer 125 are contained in housing 180 (FIG. 3). In one embodiment, these elements are located in close proximity to each other. The proximity of elements contribute to the apparatus' portability and ease of use in a variety of clinical settings, including both inside and outside of an operating room.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A fuse system for a hyperthermia apparatus, the fuse system comprising:
a disposable reservoir cartridge configured to be used with a hyperthermia apparatus, wherein the disposable reservoir cartridge comprises at least a first lockout circuit and a second lockout circuit, wherein the first lockout circuit comprises a first fuse link, wherein the second lockout circuit comprises a second fuse link;
a computing device in communication with the first lockout circuit and the second lockout circuit; and
a computer-readable storage medium in communication with the computing device, wherein the computer-readable storage medium comprises one or more programming instructions for:
deactivating the first fuse link at a first time, and
deactivating the second fuse link at a second time.

2. The fuse system of claim 1, wherein the one or more programming instructions for deactivating the first fuse link comprise one or more programming instructions for deactivating the first fuse link when the hyperthermia apparatus is powered on.

3. The fuse system of claim 1, wherein the one or more programming instructions for deactivating the first fuse link comprise one or more programming instructions for deactivating the first fuse link a certain time period after the hyperthermia apparatus has been powered on.

4. The fuse system of claim 1, wherein the one or more programming instructions comprise one or more programming instructions for:
in response to deactivation of the first fuse link and the second fuse link, preventing use of the disposable reservoir cartridge by the hyperthermia apparatus.

5. The fuse system of claim 1, wherein the one or more programming instructions comprise one or more programming instructions for allowing use of the disposable reservoir cartridge by the hyperthermia apparatus if both the first fuse link and the second fuse link are intact.

6. The fuse system of claim 1, wherein the one or more programming instructions comprise one or more programming instructions for allowing use of the disposable reservoir cartridge by the hyperthermia apparatus if only the second fuse link is intact.

7. The fuse system of claim 1, wherein the one or more programming instructions comprise one or more programming instructions for:
In response to completion of a procedure utilizing the hyperthermia apparatus, deactivating the second fuse link.

8. The fuse system of claim 7, wherein the one or more programming instructions for determining whether a procedure utilizing the hyperthermia apparatus has been completed comprise one or more programming instructions for:
receiving confirmation that the procedure has been completed from a user; and
in response to receiving confirmation, deactivating the second fuse link.

9. The fuse system of claim 1, wherein the one or more programming instructions comprise one or more programming instructions for:
in response to expiration of a period of time after the hyperthermia apparatus was powered on, deactivating the second fuse link.

10. The fuse system of claim 1, wherein the one or more programming instructions comprise one or more programming instructions for:
in response to expiration of a period of time after the first fuse link was deactivated, deactivating the second fuse link.

11. The fuse system of claim 1, wherein the one or more programming instructions comprise one or more programming for:
in response to a period of time associated with a procedure elapsing, deactivating the second fuse link.

12. A fuse system for a hyperthermia apparatus, the fuse system comprising:
a disposable reservoir cartridge configured to be used with a hyperthermia apparatus, wherein the disposable reservoir cartridge comprises at least a first lockout circuit and a second lockout circuit, wherein the first lockout circuit comprises a first fuse link, wherein the second lockout circuit comprises a second fuse link;
a computing device in communication with the first lockout circuit and the second lockout circuit; and
a computer-readable storage medium in communication with the computing device, wherein the computer-readable storage medium comprises one or more programming instructions for:
deactivating the first fuse link at a start of a procedure, and
deactivating the second fuse at a time after the first fuse link is deactivated.

13. The fuse system of claim 12, wherein the one or more programming instructions for deactivating the first fuse link comprise one or more programming instructions for deactivating the first fuse link when the hyperthermia apparatus is powered on.

14. The fuse system of claim 12, wherein the one or more programming instructions for deactivating the first fuse link comprise one or more programming instructions for deactivating the first fuse link a certain time period after the hyperthermia apparatus has been powered on.

15. The fuse system of claim 12, wherein the one or more programming instructions comprise one or more programming instructions for:
in response to deactivation of the first fuse link and the second fuse link, preventing use of the disposable reservoir cartridge by the hyperthermia apparatus.

16. The fuse system of claim 12, wherein the one or more programming instructions comprise one or more programming instructions for allowing use of the disposable reservoir cartridge by the hyperthermia apparatus if both the first fuse link and the second fuse link are intact.

17. The fuse system of claim 12, wherein the one or more programming instructions comprise one or more programming instructions for allowing use of the disposable reservoir cartridge by the hyperthermia apparatus if only the second fuse link is intact.

18. The fuse system of claim 12, wherein the one or more programming instructions comprise one or more programming instructions for:
in response to completion of a procedure utilizing the hyperthermia apparatus, deactivating the second fuse link.

19. The fuse system of claim 18, wherein the one or more programming instructions for determining whether a procedure utilizing the hyperthermia apparatus has been completed comprise one or more programming instructions for:
receiving confirmation that the procedure has been completed from a user; and
in response to receiving confirmation, deactivating the second fuse link.

20. The fuse system of claim 18, wherein the one or more programming instructions comprise one or more programming instructions for:
in response to expiration of a period of time after the hyperthermia apparatus was powered on, deactivating the second fuse link.

21. The fuse system of claim 18, wherein the one or more programming instructions comprise one or more programming instructions for:
in response to expiration of a period of time after the first fuse was deactivated, deactivating the second fuse link.

22. The fuse system of claim 18, wherein the one or more programming instructions comprise one or more programming for:
in response to a period of time associated with a procedure elapsing, deactivating the second fuse link.
